(19) United States
(12) Patent Application Publication
(10) Pub. No.: US 2013/0080831 A1
(43) Pub. Date: Mar. 28, 2013

(54) STORAGE APPARATUS, SYSTEM, AND CONTROL METHOD

(71) Applicants: Hiroaki NISHIJO, Kawasaki (JP); Yasuhiko Hanaoka, Inagi (JP)

(72) Inventors: Hiroaki NISHIJO, Kawasaki (JP); Yasuhiko Hanaoka, Inagi (JP)

(73) Assignee: FUJITSU LIMITED, Kawasaki-shi (JP)

(21) Appl. No.: 13/607,936

(22) Filed: Sep. 10, 2012

(30) Foreign Application Priority Data
Sep. 27, 2011 (JP) 2011-210043

(51) Int. Cl. G06F 12/02; G06F 11/07

(52) U.S. Cl. 714/15; 711/165; 714/54; 711/E12.002; 714/E11.023; 714/E11.024

(57) ABSTRACT

A storage apparatus includes a storage drive which writes and reads out a block of data with respect to a storage medium loaded on the storage apparatus, a processor which executes access control on a plurality of volumes assigned to the storage medium and a memory which stores a piece of management information that includes a piece of information indicating a usage frequency of each of the volumes. The processor executes a procedure including: determining a reallocation target volume from among a plurality of volumes assigned to the storage medium based on the management information, and moving the data of the reallocation target volume to a reallocation destination storage medium which is different from the storage medium.

### CROSS-REFERENCE TO RELATED APPLICATIONS

This application is based upon and claims the benefit of priority of the prior Japanese Patent Application No. 2011-210043, filed on Sep. 27, 2011, the entire contents of which are incorporated herein by reference.

### FIELD

The embodiments discussed herein are related to a storage apparatus, a system, and a control method.

### BACKGROUND

Conventionally, a magnetic tape device and an optical disk device have been known as a storage apparatus that backups and stores a data file to be processed in a host computer. In the magnetic tape device, a data file is recorded by volume unit in a single magnetic tape medium.

In recent years, as processing performance of the magnetic tape device has been improved and high recording density of the magnetic tape medium has been enhanced, the data amount that may be stored in a single magnetic tape medium increases several hundred times to several thousand times as large as the amount of one volume of the data file.

If the above-described magnetic tape that is large-capacity recordable is used by a recording method by one medium/one volume unit, the start edge of the medium is partially used, and the rest of the medium is blank. Thus, the usage of the medium is inefficient.

Writing and reading-out of data desired by the host computer are performed by volume unit, that is, medium unit. Therefore, for processing of a large volume, mount/unmount of the magnetic tape medium on the magnetic tape drive for each access target volume is repeated. Since exchanging operation of magnetic tape mediums associated with mechanical operations takes time, the medium exchanging operation time accounts for a large percentage of the total processing time of all the data.

As a result, the data file of several volumes is stored in a single magnetic tape medium and is then handled as a virtual magazine. Due to this, the storage efficiency may be improved by making the most of the medium capacity. The virtual magazine actually has a single magnetic tape medium and a single magnetic tape drive. However, the virtual magazine virtually pretends to the host computer that a plurality of magnetic tape mediums are mounted on a plurality of magnetic tape drives.

However, since a plurality of volumes is assigned to a single medium, the accesses concentrate in part of the volumes, and usage of the medium may be biased. Especially, in a case of a Linear Tape Open (LTO) medium, if the accesses concentrate in a latter part of the magnetic tape medium, the efficiency of the medium decreases due to an increase of access time.

Due to excessive access of a volume, an error occurrence rate of the volume increases. This may shorten the life of the medium. Accordingly, the magnetic tape medium that is large-capacity recordable may not be used efficiently.

### SUMMARY

According to an aspect of the invention, a storage apparatus includes a storage drive which writes and reads out a block of data with respect to a storage medium loaded on the storage apparatus, a processor which executes access control on a plurality of volumes assigned to the storage medium and a memory which stores a piece of management information that includes a piece of information indicating a usage frequency of each of the volumes. The processor executes a procedure including: determining a reallocation target volume from among a plurality of volumes assigned to the storage medium based on the management information, and moving the data of the reallocation target volume to a reallocation destination storage medium which is different from the storage medium.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a diagram illustrating a configuration of a computer system;

FIG. 2 is a diagram illustrating a configuration of a control unit of a storage apparatus;

FIG. 3 is a diagram illustrating a volume bulk-write processing method;

FIGS. 4A and 4B are a diagram illustrating a recording format of a magnetic tape;

FIG. 5 is a diagram illustrating an example of a volume management table;

FIG. 6 is a diagram illustrating an example of a volume index table;

FIG. 7 is a diagram illustrating a movement determining processing of a multi-access volume;

FIG. 8 is another diagram illustrating the movement determining processing of the multi-access volume;

FIG. 9 is another diagram illustrating the movement determining processing of the multi-access volume;

FIG. 10 is another diagram illustrating the movement determining processing of the multi-access volume;

FIG. 11 is a diagram illustrating a movement determining processing of an error occurrence volume;

FIG. 12 is another diagram illustrating the movement determining processing of the error occurrence volume;

FIG. 13 is a diagram illustrating a moving processing of a volume;

FIG. 14 is another diagram illustrating the moving processing of the volume;

FIG. 15 is another diagram illustrating the moving processing of the volume;

FIG. 16 is a diagram illustrating a collective moving processing of all the volumes; and

FIG. 17 is another diagram illustrating the collective moving processing of all the volumes.

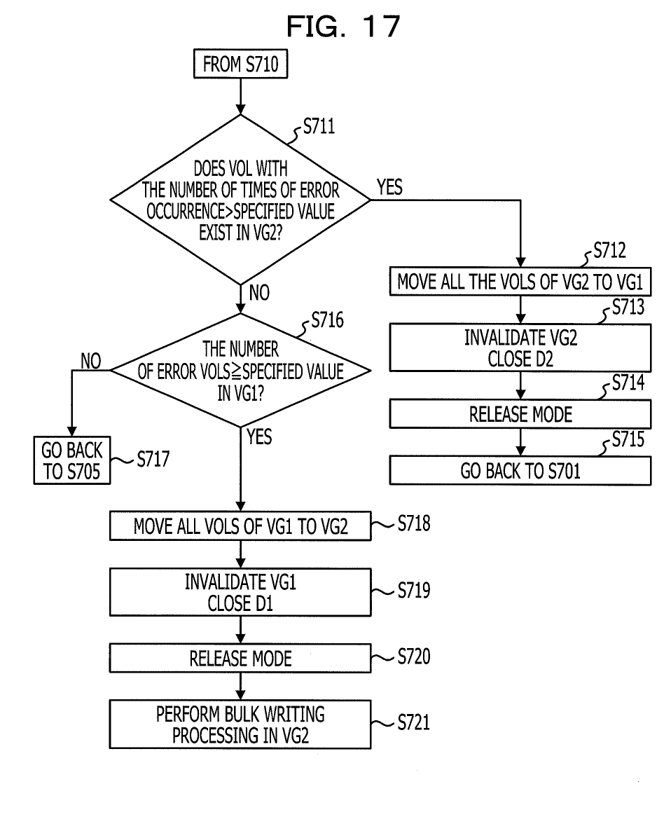

### DESCRIPTION OF EMBODIMENTS

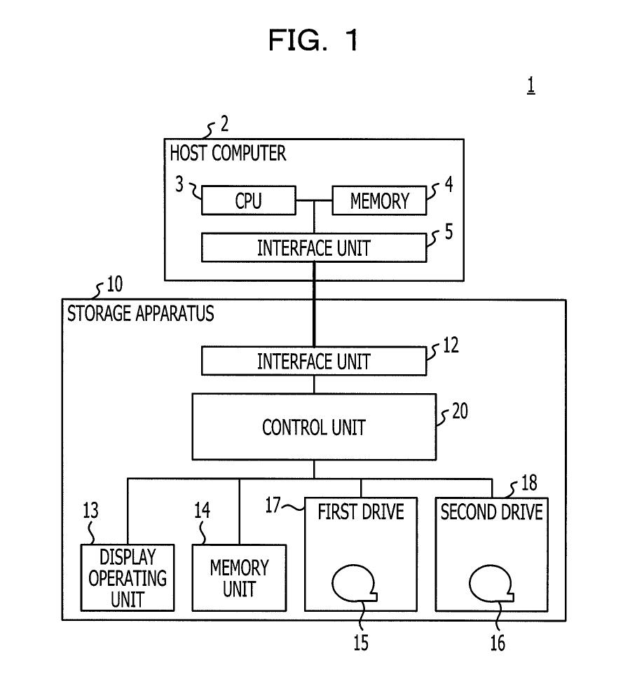

The embodiments will be described in detail below with reference to the diagrams. FIG. 1 is a diagram illustrating a configuration of a computer system 1. The computer system 1 includes a host computer 2 and a storage apparatus 10.

For example, the host computer 2 is a server device or the like that processes data. The host computer 2 includes at least a Central Processing Unit (CPU) 3 that executes various types of control, a memory 4 that stores programs and management information to be used by the CPU 3, and an interface unit 5 that is coupled to an external device. Although an example of the interface unit 5 indicates a fiber channel adaptor, another type of interface circuit is applicable. For example, by processing of a program, an access request to the storage apparatus 10 is transmitted from the CPU 3 to the storage apparatus 10 through the interface unit 5. If the access request indicates the read processing, the data transmitted from the storage apparatus 10 in response to the access request is received through the interface unit 5.

The storage apparatus 10 performs recording and reproduction with respect to a removable storage medium. Although the embodiments describe an example of usage of a magnetic tape medium and a magnetic tape drive, the embodiments may apply to an optical disk medium and an optical disk drive.

The storage apparatus 10 includes an interface unit 12, a control unit 20, a display operating unit 13, a memory unit 14, a first drive 17, and a second drive 18. The interface unit 12 is coupled to the interface unit 5 of the host computer 2 to transmit and receive data. The interface unit 12 is typically an interface circuit of the similar type of the interface unit 5. The control unit 20 controls the whole storage apparatus and performs the recording of the data into the magnetic tape medium or reproduction control of the data.

The display operating unit 13 includes a display that displays information indicating a state of the storage apparatus 2 and an operation panel that is to be operated by an operator. The memory unit 14, to which a non-volatile semiconductor memory is attached, performs the recording or the reproduction of the data with respect to the semiconductor memory.

The first drive 17 and the second drive 18 are a magnetic tape drive. Cartridge magnetic tape mediums 15 and 16 are loaded into the first drive 17 and the second drive 18, respectively. The first drive 17 and the second drive 18 include a drive mechanism unit that performs writing operation or reading-out operation of a serial data set by making a tape, which is winded from a reel inside a cartridge, run on a magnetic head while winding the tape on another reel. Based on an instruction from the control unit 20, the first drive 17 and the second drive 18 perform recording or reproducing processing with respect to the magnetic mediums 15 and 16.

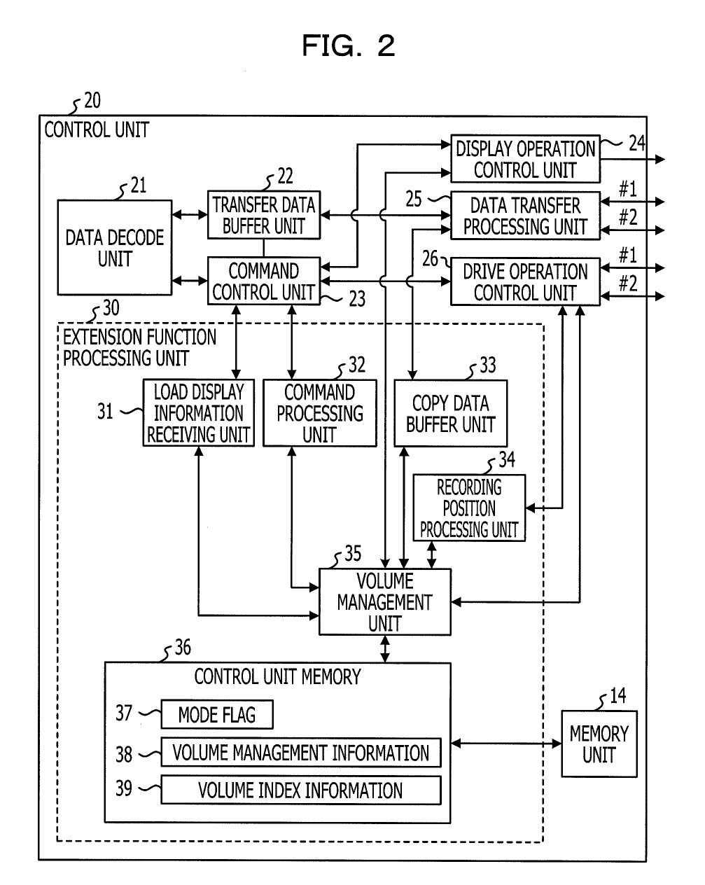

FIG. 2 is a diagram illustrating a configuration of the control unit 20 in the storage apparatus 10. The control unit 20 includes a data decode unit 21, a transfer data buffer unit 22, a command control unit 23, a display operation control unit 24, a data transfer processing unit 25, a drive operation control unit 26, and an extension function processing unit 30.

The control unit 20 may include a processor such as a CPU and a memory used to operate a program on the processor. Further, the processor may be coupled to the memory by a bus. The command control unit 23, the display operation control unit 24, the data transfer processing unit 25, the drive operation control unit 26, and the like may be configured when the processor executes the program stored in the memory or the like.

The data decode unit 21 processes the command received by the interface unit 12 and also processes transfer data. The transfer data buffer unit 22 is used to transfer a data block that is recorded/reproduced in a medium.

The command control unit 23 instructs various operations with respect to the first drive 17 and the second drive 18 based on the command from the host computer 2 and replies processing results to the host computer 2. The display operation control unit 24 outputs medium information of a medium as a processing target and an operation request message to the display operating unit 13 and displays the information and the operation request message on the display of the display operating unit 13.

The data transfer processing unit 25 collects and transmits the data transferred from the host computer 2 in a data group by recording unit to the first drive 17 or the second drive 18. The data transfer processing unit 25 transmits the data group transferred from the first drive 17 or the second drive 18 to the host computer 2.

The drive operation control unit 26 instructs the processing operation of the first drive 17 and the second drive 18 and monitors the operations. Further, the drive operation control unit 26 performs switching between the first drive 17 and the second drive 18.

The extension function processing unit 30 performs processing for efficiently using a large-capacity recordable medium. The extension function processing unit 30 includes a load display information receiving unit 31, a command processing unit 32, a copy data buffer unit 33, a recording position processing unit 34, a volume management unit 35, and a control unit memory 36.

The load display information receiving unit 31, the command processing unit 32, the record position processing unit 34, and the volume management unit 35 may be configured if the processor executes the program stored in an internal memory or a storage medium.

The load display information receiving unit 31 receives a load display command that is issued following a mount command by the host computer 2 and performs processing for obtaining volume label information from a host message included in the load display command.

The mount command is used to mount a medium as a processing target on a drive as a processing target and to place the magnetic head in the head of the tape medium. The load display command is used to read out medium management information from the tape medium as a processing target.

Based on the medium management information, the load display information receiving unit 31 generates a volume management table in which the volume label, the volume (data set), and recording position information are associated with each other. The load display information receiving unit 31 further refers to the volume management table to obtain a data recording position corresponding to a desired volume.

The command processing unit 32 processes the mount command corresponding to the desired volume, mounts the medium to which the desired volume is assigned, and performs control for positioning the magnetic head in the recording position of the desired volume. The command processing unit 32 outputs a command complete response corresponding to the mount command to the host computer 2.

The copy data buffer unit 33 is used to temporally store the data when the data is moved between the first drive 17 and the second drive 18. The recording position processing unit 34 obtains the recording position information (data block number) of each volume on the tape medium from the drive and then outputs the recording position information to the volume management unit 35.

The volume management unit 35 logically processes the volume as a data set, assigns a plurality of volumes as a plurality of data sets in a single tape medium, and performs the control for bulk writing to be performed.

The volume management unit 35 performs reallocation control of the volume according to a usage frequency and an error occurrence state. Based on the recording position information of each volume output from the recording position processing unit 34, the volume management unit 35 creates and updates volume management information and volume index information.

The control unit memory 36 includes a mode flag storage area 37, a volume management information storage area 38, and a volume index information storage area 39. The mode flag storage area 37, the volume management information storage area 38, the volume index information storage area 39 stores a mode flag, volume management information, and volume index information, respectively.

When the volume management unit 35 is set to a load distribution processing mode, the mode flag is overwritten by 1 (valid) from 0 (invalid). On the contrary, if the volume management unit 35 is released from the load distribution processing mode, the mode flag is rewritten into 0 (invalid) from 1 (valid).

Since the volume index information is basic information of the whole medium used to manage the storage apparatus 10, the volume index information is copied, from the control unit memory 36, as backup in a non-volatile semiconductor memory in the memory unit 14.

When the storage apparatus 10 is replaced, the volume index information is obtained from the semiconductor memory and is then succeeded. The volume index information may be stored in a storage medium such as a tape medium instead of the semiconductor memory.

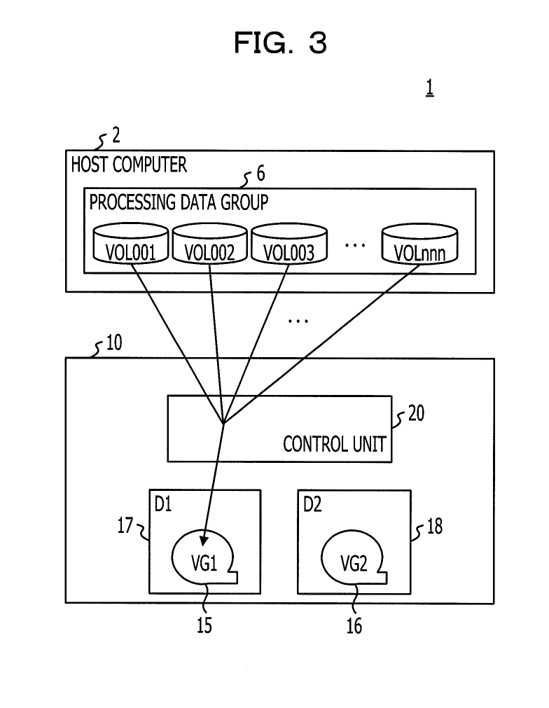

FIG. 3 is a diagram illustrating a volume bulk-write processing method. FIG. 3 illustrates that a processing data 6 of a plurality of volumes VOL001 to VOLnnn that is data-processed by the host computer 2 is transferred to the tape medium 15 in the storage apparatus 10.

The host computer 2 issues a mount command with respect to the medium associated with each volume to the storage apparatus 10. The tape medium (VG1) 15 mounted on the first drive (D1) 17 is a bulk writable large-capacity tape medium.

When receiving the data file of one volume to be recorded in a single tape medium from the host computer 2, the control unit 20 performs volume converting processing and handles the data file as a single data set (logic volume) that includes the volume label information. The control unit 20 records a plurality of volume groups in a multi-file format that includes a plurality of logic volumes.

That is, the storage apparatus 10 pretends to process the desired volume in a separate tape medium with respect to the host computer 2 and performs, by the control unit 20, bulk-write processing of the plurality of volumes in a single tape medium (bulk writing medium) by using the volume management table.

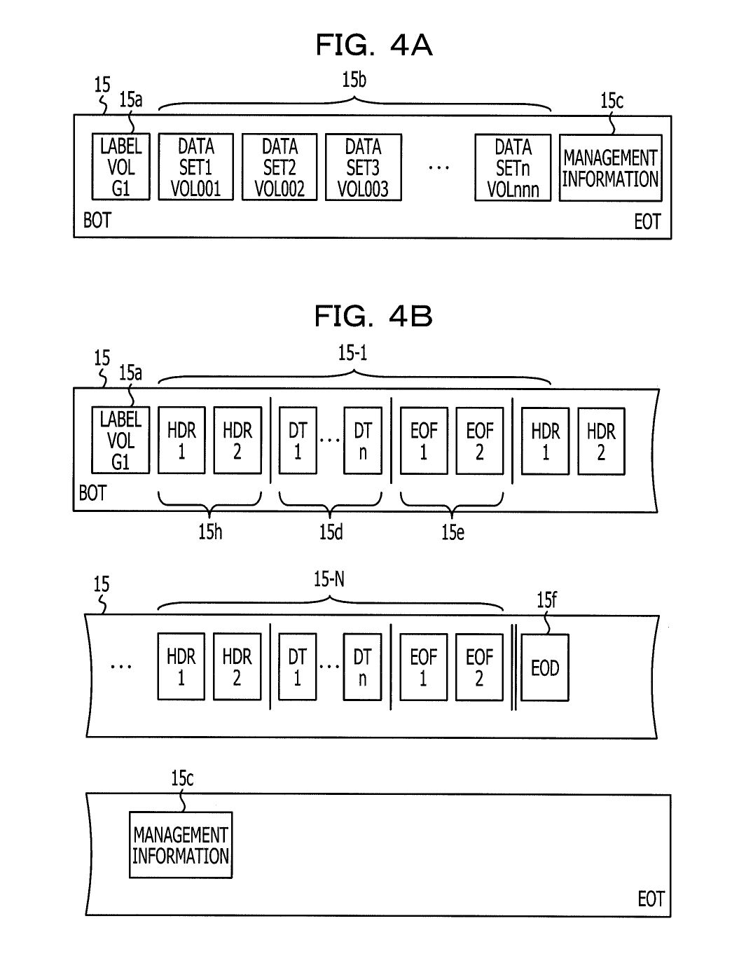

FIGS. 4A and 4B are a diagram illustrating a recording format of the magnetic tape. As illustrated in FIG. 4A, a volume label unit 15a provided in the head of the tape medium 15 records a logic volume group number VOLG1 that represents the logic volume group compiled in a single tape medium.

Each data set of volumes VOL001 to VOLnnn is recorded in a storage area 15b. A management information recording area 15c is added to the edge part of the recorded data. The management information recording area 15c records medium management information such as volume management information that is used to manage all the volumes assigned to the medium.

As illustrated in FIG. 4B, recording areas 15-1 to 15-N of the data set of the volumes record headers (HDR1, HDR2) indicating the file start, data units (DT1 to DTn) 15d, and end flags (EOF1, EOF2) indicating a file end, respectively.

The latter part of the recording area 15-N records a data recording end flag (EOD) 15f indicating the end of the data recording, and the management information recording area 15 records the medium management information. The area from the latter part to the end edge (EOT) of the tape medium 15 is an empty area in which no date is recorded.

When another volume is written, the volume is added after the last edge data set. The medium management information that is added with the volume number and the writing position of the data set is further added after the volume, and the old medium management information is invalidated.

To rewrite the existing data volume, the data to be updated is added after the last edge data set in the similar manner of new writing. The data set positioned in the old data unit of the volume is invalidated, and the medium management information in which the position of the added data set is updated to the writing position of the volume. The old medium management information is invalidated.

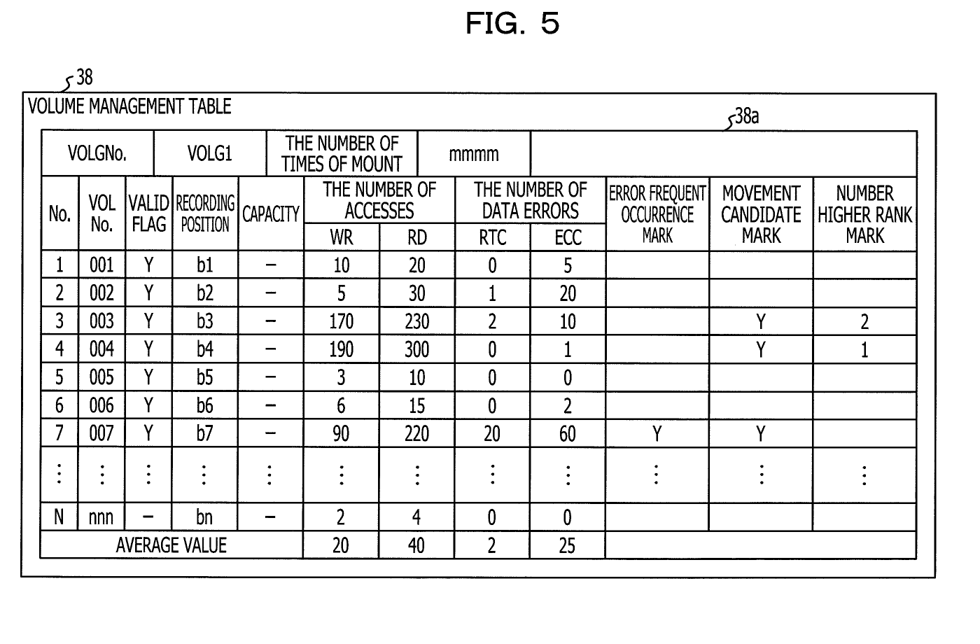

FIG. 5 is a diagram illustrating an example of the volume management table. When the data set corresponding to the first volume is written into an unrecorded tape medium, another volume management table is newly created and is then additionally recorded in the volume management storage area 38 in the control unit memory 36.

Every time the data set corresponding to the volume is recorded in the tape medium, registration information of the volume management table is updated. Part of the registration information of the volume management table is written into the management information recording area 15c in the tape medium.

When the tape medium is loaded into the first drive 17 or the second drive 18, the volume management unit 35 reads out the medium management information of the edge part of the recorded data from the tape medium. The volume management table is created based on the read-out medium management information and is then stored in the volume management information storage area 38.

The volume management table is created for each volume group (medium). FIG. 5 illustrates a volume management table 38a of which the volume group number is VG1. The management information is recorded in the volume management table 38a based on the medium management information that is read out from the bulk writing medium (VOLG1) 15.

The contents of the management information include a volume group number (VOLGNo.) of a medium, a mount number, a recording number (No.), an actual volume number (VOLNo.), a valid flag of each volume, and a recording position and an amount (MB) of each volume. The mount number, which indicates the number of times of mount on the drive of the medium, is used as an index indicating the number of times of usage of the medium.

When each volume is rewritten or when the reallocation associated with inter-medium movement described below is performed, a valid flag of the original volume is released, and the field for the valid flag in the volume management table is cleared.

In this manner, even if the original volume remains physically recorded in the medium, the original volume is invalidated by referring the valid flag in the volume management table. Since the valid flag of the rewritten volume is added to the field for the valid flag in the volume management table, the rewritten volume may be accessed.

In the field of the number of accesses in the volume management table 38a, the number of times of write processing (WR) and the number of times of read processing (RD) are recorded. The number of times of write processing (WR) and the number of times of read processing (RD) are an example of information indicating the usage frequency of each volume.

In the field for the number of data errors in the volume management table 38a, the number of times of retry (RTC) and the number of times of error correction (ECC) are recorded. The number of times of retry (RTC) and the number of times of error correction (ECC) are an example of information indicating an error occurrence state of each volume.

The average value of the above-described numbers is calculated by the volume management unit 35 and is then recorded in the field for the average value. Further, an error frequent occurrence mark, a movement candidate mark, and a number higher rank mark are recorded in the volume management table 38a. The above-described marks will be described below.

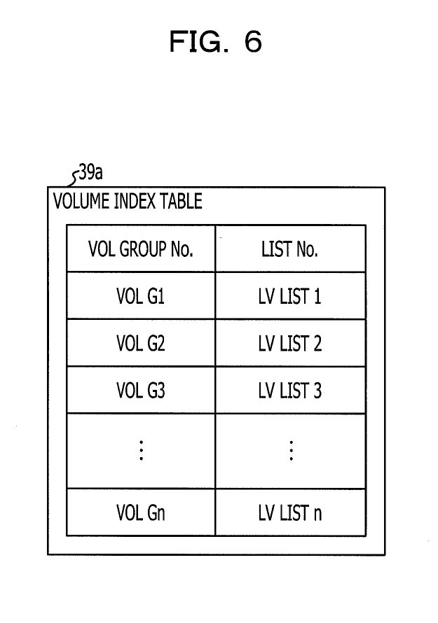

FIG. 6 is a diagram illustrating an example of a volume index table. In the volume index table 39a stored in the volume index information storage area 39, a volume group number (VOL group NO.) and a logic volume list (LV list) are recorded. The volume group number (for example, VOLG1 to VOLGn) is added to each tape medium.

In the LV list, the volume label indicating an actual volume number of each volume and a block number indicating the head of the position of the data set on the tape medium corresponding to each volume are recorded. By the volume index table 39a, the control unit 20 confirms the tape medium of which volume group number in which the desired volume is stored.

By using the registration information in the volume management table 38a, the volume index table 39a is updated. In the volume management information storage area 38, the information of the volume management table of the medium that is processed in the past is amassed and stored.

Based on the information, the volume index table is created as a list indicating a relation between all the mediums mounted on the device and the volumes stored in all the mediums, so that the individual volume may be referred with respect to the aggregation of all the mediums.

When the information of the volume management table in the volume management information storage area 38 is updated, the information of the volume index table is updated. Further, the medium management information on the tape medium is rewritten into the updated medium management information.

The access load distribution function will be described below. When using a plurality of bulk writable large-capacity mediums, the volume management unit 35 performs volume assignment management. When many volumes are written into a single tape medium, the accesses are biased in part of the volumes. Especially, when the accesses concentrate in the end part of the tape medium, the processing efficiency may decrease due to an increase of the access time.

When two or more drives are coupled in the magnetic tape drive, two or more mediums may be managed and used as a combination. By managing the volume to be stored in two or more tape mediums, the usage efficiency is optimized.

As illustrated in FIG. 1, when two drive and two mediums are concurrently used, the bulk writable large-capacity tape medium (VG1) 15 is mounted on the first drive (D1) 17, and the bulk writable large capacity tape medium (VG2) 16 is mounted on the second drive (D2) 18.

The volume management unit 35 monitors the usage state of all the volumes based on the volume management table stored in the medium management information storage area 38. If the volume management unit 35 detects access concentration for writing or reading-out from the host computer 2 in a specific volume in the medium (VG1) 15, the volume management unit 35 automatically moves the data of the volume to the new medium (VG2) 16.

The bulk-write processing is processing for assigning a plurality of volumes to a single medium and performing bulk writing of a data set of the plurality of volumes into the medium. The medium (VG1) 15 will be described below as a bulk writing medium that performs the bulk-write processing.

Regarding the bulk writing medium (VG1) 15, when the stored volume is updated repeatedly, storage efficiency decreases due to an increase of an invalidated area as the old data set.

When the invalid area increases as described above, the valid data set is aggregated by being copied to another medium with reference to the volume management table, and the new medium (VG2) 16 of which the storage efficiency is improved eventually is used.

As with the bulk writing medium (VG1) 15, the new medium (VG2) 16 may perform the bulk-write processing inside the medium itself. When simply a single volume is written into the new medium (VG2) 16, the medium (VG2) 16, as the regular single volume medium, is subjected to the regular write processing as with the tape medium recorded in a single volume format (standard format).

According to the embodiments, by moving the volume of which the usage frequency is biased from the bulk writing medium (VG1) 15 to the new medium (VG2) 16, the accesses from the host computer 2 are distributed into two drives/two mediums.

The volume management unit 35 monitors the usage frequency of all the volumes at all times with reference to the information of the volume management table and reallocates the volume with high usage frequency in the new medium (VG2) 16. That is, the new medium (VG2) 16 is a storage medium for multi-access volume (hereinafter referred to as multi-access medium) in which the volumes with high usage frequency are aggregated.

After that, when the usage frequency decreases, the volume with the decreased usage frequency is reallocated in the bulk writing medium (VG1) 15. According to the embodiments, by performing volume allocation management while dynamically repeating the above-described moving processing, optimization of storage efficiency and access performance of the volume is performed by keeping a good balance between the storage efficiency and the access performance of the volume.

The embodiments describe an example of usage of two drives. However, the configuration may have a plurality of drives and a plurality of mediums that are concurrently operated. According to the embodiments, the volumes are divided into groups in descending order of usage frequency (access concentration) and distributed into a plurality of mediums according to the access number. This further improves the efficiency of the access load distribution.

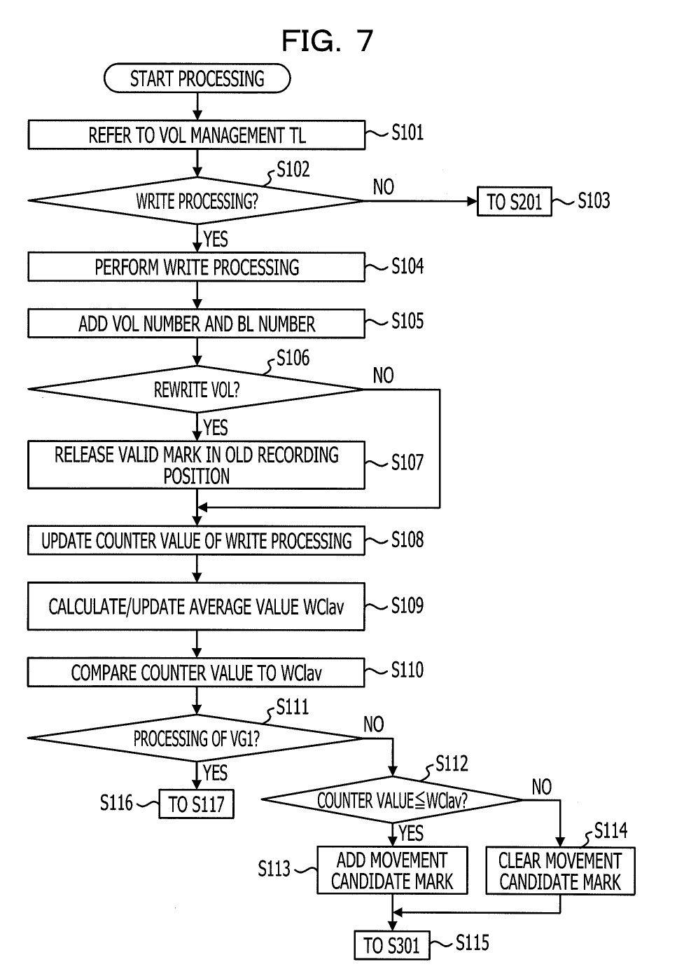

FIG. 7 is a diagram illustrating movement determining processing of a multi-access volume. When receiving the command of the access request from the host computer 2, the volume management unit 35 refers to the volume management table of the volume group of the access target (Operation S101). If the access request does not indicate the write processing to be performed on the access target volume (NO in Operation S102), the process goes to the read processing in Operation S201 (Operation S103).

If the access request indicates the write processing (YES in Operation S102), the control unit 20 performs the write processing (Operation S104). The volume management unit 35 additionally resisters a volume (VOL) number of the access target volume and a recording position block (BL) number in the volume management table (Operation S105).

If the access request does not indicate the rewrite processing of the volume (NO in Operation S106), the process goes to the determination in Operation S108. If the access request indicates the rewrite processing of volume (YES in Operation S106), the volume management unit 35 releases the valid mark in the old recording position of the access target volume in the volume management table (Operation S107).

If the access request indicates the existing volume rewriting, the drive additionally writes update data after the volume in the last edge of the loaded tape medium. The volume management unit 35 releases and indicates the valid mark in the old recording position in the volume management table and then adds the valid mark in the recording position of the added volume.

The volume management unit 35 updates the counter value of the write processing and rewrites the number of times of write processing number (WR) in the volume management table (Operation S108). Further, the volume management unit 35 calculates an average value WCav of the write processing of all the volumes and rewrites the average value of the write processing in the volume management table (Operation S109).

The volume management unit 35 compares the counter value to the average value WClav (Operation S110). If the write processing targets the bulk writing medium (VG1) 15 (YES in Operation S111), the process goes to the determination in Operation S117 (Operation S116).

On the other hand, if the write processing does not target the bulk writing medium (VG1) 15 (NO in Operation S111), the volume management unit 35 determines whether the counter value is equal to or lower than the average value WClav.

If the counter value is equal to or lower than the average value WClav (YES in Operation S112), the volume management unit 35 selects the access target volume as a volume of the reallocation target associated with the inter-medium movement and then adds the movement candidate mark (Operation S113). That is, the volume management unit 35 records Y in the field for the movement candidate mark of the access target volume in the volume management table.

In this manner, the volume, of which the usage frequency is determined to be decreased, becomes a reallocation target to be put back to the medium (VG1) 15 in the medium (VG2) 16. The process goes to the determination in Operation S301 (Operation S115).

If the counter value is larger than the average value WClav (NO in Operation S112), the volume management unit 35 clears the movement candidate mark in the volume management table (Operation S114). The process goes to the determination in Operation S301 (Operation S115).

Accordingly, if the counter value is larger than the average value WClav, the volume is determined to be a multi-access volume. Such volume is excluded from the reallocation target in the medium (VG2) 16. According to the embodiments, the medium (VG2) 16 is a multi-access medium that collects and stores the volumes that are determined to be a multi-access volume.

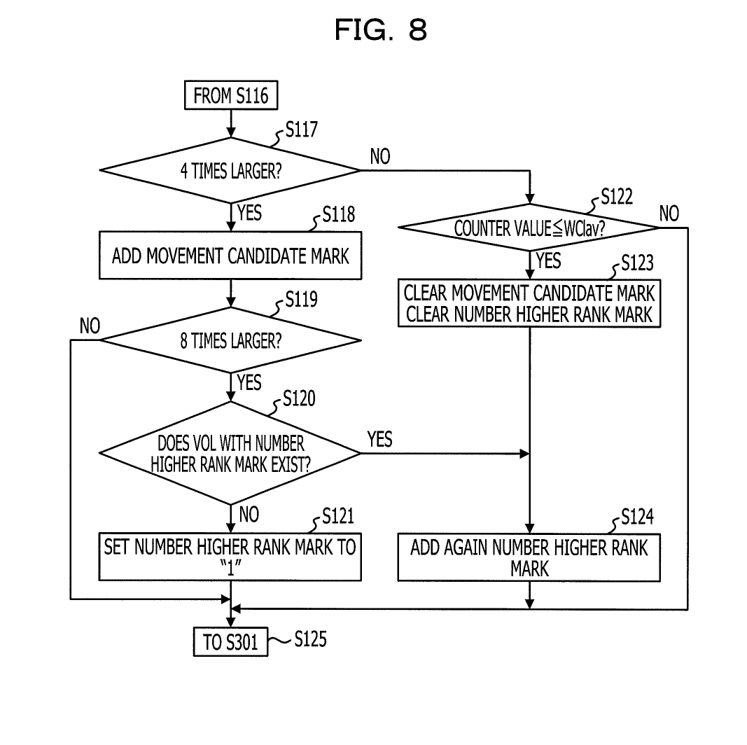

FIG. 8 is a diagram illustrating the movement determining processing of the multi-access volume and illustrating the processing following Operation S116. The volume management unit 35 determines whether the counter value exceeds the value that is four times as large as the average value WClav calculated in Operation S109 (Operation S117). If the counter value exceeds the value that is four times as large as the average value WClav (YES in Operation S117), the volume management unit 35 selects the access target volume as the volume of the reallocation target associated with the inter-medium movement and then adds the movement candidate mark in the volume management table (Operation S118).

The volume management unit 35 determines whether the counter value exceeds the value that is eight times as large as the average value WClav. If the counter value exceeds the value that is eight times as large as the average value WClav (YES in Operation S119), the volume management unit 35 determines whether a volume with a number higher rank mark exists among all the volumes of the bulk writing medium (VG1) 15. The counter value does not exceed the value that is eight times as large as the average value WClav (NO in Operation S119), the process goes to the determination in Operation S301 (Operation S125).

If the volume with the number higher rank mark exists (YES in Operation S120), the process goes to the processing in Operation S124. The number higher rank mark indicates the rank added to the volume in descending order of the number of accesses where the volume of which the counter value exceeds the value that is eight times as large as the counter value of the write processing or of which the number of times of reading-out exceeds the volume that is 16 times as large as the counter value. [0090] If the volume with the number higher rank mark does not exist (NO in Operation S120), the volume management unit 35 records 1 in the field for the number higher rank mark of the access target volume in the volume management table (Operation S121). The process goes to the determination in Operation S301 (Operation S125).

If the counter value is equal to or smaller than the value that is four times as large as the average value WClav (NO in Operation S117), the volume management unit 35 determines whether the counter value is equal to or smaller than the average value WClav (Operation S122). If the counter value is larger than the average value WClav (NO in Operation S122), the process goes to the determination in Operation S301 (Operation S125).

If the counter value is equal to or smaller than the average value WClav (YES in Operation S122), the volume management unit 35 clears the movement candidate mark and the number higher rank mark in the volume management table (Operation S123). The volume management unit 35 refers to the writing counter value of the volume that is added with the number higher rank mark and again adds the number higher rank mark in descending order of counter value with respect to the above-described volumes (Operation S124). The process goes to the determination in Operation S301 (Operation S125).

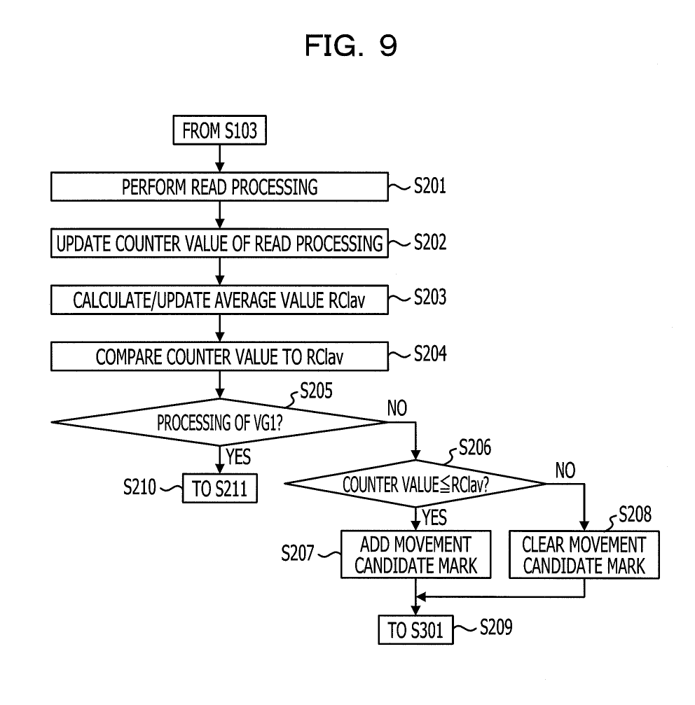

FIG. 9 is a diagram illustrating the movement determining processing of the multi-access volume and illustrating the processing following Operation S103. Based on the determination result from Operation S103, the volume management unit 35 performs the read processing for the access target volume (Operation S201).

The volume management unit 35 updates the counter value of the read processing and rewrites the field for the number of times of read processing (RD) in the volume management table (Operation S202). The volume management unit 35 calculates an average value RClav of the read processing of all the volumes and then rewrites the field for the average value of the read processing in the volume management table (Operation S203).

The volume management unit 35 compares the counter value to the average value RClav (Operation S204). If the read processing targets the bulk writing medium (VG1) 15 (YES in Operation S205), the process goes to the determination in Operation S211 (Operation S210).

If the read processing does not target the bulk writing medium (VG1) 15 (NO in Operation S205), that is, if the read processing targets the medium (VG2) 16 as a multi-access medium, the volume management unit 35 determines whether the counter value is equal to or smaller than the average value RClav (Operation S206).

If the counter value is smaller than the average value RClav (YES in Operation S206), the volume management unit 35 selects the access target volume as the volume of the reallocation target associated with the inter-medium movement and then adds the movement candidate to the volume (Operation S207). That is, the volume management unit 35 records Y in the field for the movement candidate mark of the access target volume in the volume management table.

In this manner, the volume, of which the usage frequency is determined to be decreased, becomes the reallocation target to be put back to the bulk writing medium (VG1) 15 in the multi-access medium (VG2) 16. The process goes to the determination in Operation S301 (Operation S209).

If the counter value is larger than the average value RClav (NO in Operation S206), the volume management unit 35 clears the movement candidate mark of the access target volume (Operation S208). That is, the volume management unit 35 deletes Y in the field for the movement candidate mark in the volume management table. The process goes to the determination in Operation S301 (Operation S209).

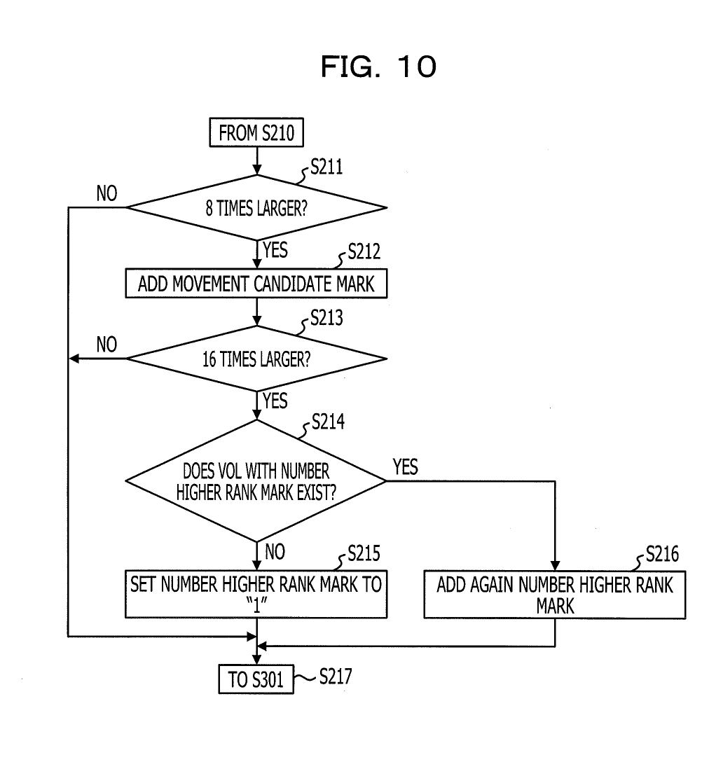

FIG. 10 is a diagram illustrating the movement determining processing of the multi-access volume and illustrating the processing following Operation S210. In Operation S210, if the read processing is determined to target the bulk writing medium (VG1) 15, the volume management unit 35 determines whether the counter value exceeds the value that is eight times as large as the average value RClav (Operation S211).

If the counter value exceeds the value that is eight times as large as the average value RClav (YES in Operation S211), the volume management unit 35 records 1 in the field for the number higher rank mark of the access target volume in the volume management table (Operation S212). If the counter value does not exceed the value that is eight times as large as the average value RClav (NO in Operation S211), the process goes to the determination in Operation S301 (Operation S217).

If the counter value exceeds the value that is 16 times as large as the average value RClav (YES in Operation S213), the volume management unit 35 determines whether the volume with the number higher rank mark exists among all the volumes of the bulk writing medium (VG1) 15.

If the volume with the number higher rank mark exists (YES in Operation S214), the volume management unit 35 refers to the writing counter value (access number) of the volume added with the number higher rank mark. The volume management unit 35 again adds the number higher rank mark to the above-described volumes in descending order of counter value (Operation S216). The process goes to the determination in Operation S301 (Operation S217).

If the volume with the number higher rank mark does not exist (NO in Operation S214), the volume management unit 35 records 1 in the field for the number higher rank mark of the access target volume in the volume management table (Operation S215). The process goes to the determination in Operation S301 (Operation S217). If the counter value does not exceed the value that is 16 times as large as the average value RClav (NO in Operation S213), the process goes to the determination in Operation S301 (Operation S217).

There are two types of number higher rank mark to be added. One is added by the reading-out number. The other one is added by the writing number. At a time of selecting the volume to be the movement candidate, the number higher rank mark that is added by the writing number is preferentially used.

Data maintenance in a case of an abnormality sign of the drive or the medium will be described below. The volume management unit 35 performs medium life management and drive failure management as the volume assignment management.

When the bulk writing of the plurality of volumes in a single tape medium is performed, the data maintenance of all the volumes is largely affected if an error of data writing/reading-out occurs due to the end of the life of the medium that is being used.

Therefore, according to the embodiment, data loss is avoided by moving all the volumes to the new medium at a time of monitoring a sign such as the life end of the medium. The embodiments illustrate an example of two drives and two mediums that are concurrently used as described above. According to the embodiments, the bulk writable large-capacity tape medium (VG1) 15 is mounted on the first drive (D1) 17, and the bulk writable large-capacity tape medium (VG2) 16 as a new medium is mounted on the second drive (D2) 18.

The volume management unit 35 monitors the usage state of all the volumes based on the volume management table information and refers to the number of times of data error occurrence that is statistically recorded at a time of performance of writing or reading-out from the host computer 2 on the volume in the bulk writing medium (VG1) 15.

The number of times of error correction obtained by correcting the read-out data error and the number of times of retry obtained by performing retry on the data block in the volume are an example of the number of times of data error occurrence and are recorded in the volume management table.

The number of times of error correction and the number of times of retry are updated every time writing or reading-out is performed with respect to each volume. The number of times of error occurrence may be the total number of the number of times of retry and error correction.

If the number of times of error occurrence of a specific volume increases and exceeds a prescribed specified value (the first threshold value, the second threshold value), the volume management unit 35 does not rewrite the data with respect to the bulk writing medium (VG1) 15 and then moves the data of the specific volume to the medium (VG2) 16 by the processing of the control unit 20.

When the number of times of error occurrence exceeds the prescribed specified value (the third threshold value) in a prescribed number of volumes (for example, 50 percent) among all the volumes of the bulk writing medium (VG1) 15, the volume management unit 35 determines that there is a sign of the life end or a failure sign due to deterioration of the medium magnetic body or deterioration of the magnetic head of the first drive (D1) 17.

If the number of times of mount of the bulk writing medium (VG1) 15 reaches a prescribed specified value (the fourth threshold value), the volume management unit 35 determines that the life of the medium is coming to the end and then stops using the bulk writing medium (VG1) 15 after moving all the volumes to the medium (VG2) 16.

Alternatively, if a warning indicating a data error caused by a failure of the first drive (D1) 17 is reported by a writing/reading-out processing mechanism unit, the volume management unit 35 stops using the bulk writing medium (VG1) 15 and the first drive (D1) 17 after moving all the volumes to the medium (VG2) 16.

In this manner, before the bulk writing medium (VG1) 15 or the first drive (D1) 17 become unusable, the data of the volume from the old bulk writing medium (VG1) 15 is automatically moved to the new bulk writing medium (VG2) 16. Accordingly, the data with a large volume that is subjected to the bulk writing into the large-capacity medium for improvement of the storage efficiency is protected.

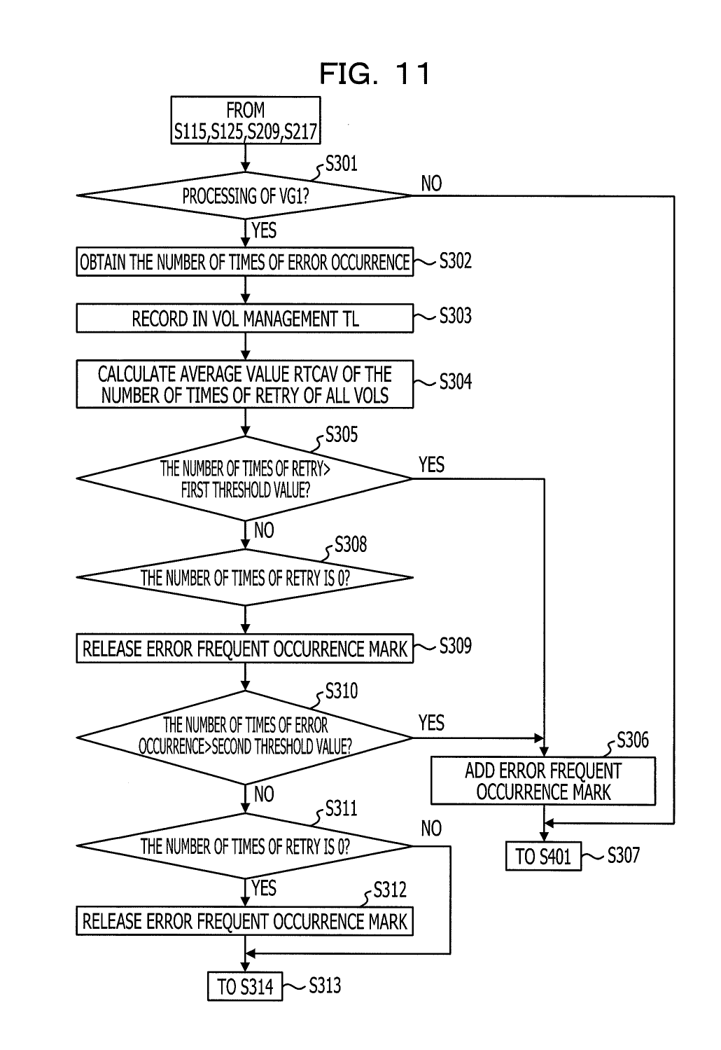

FIG. 11 is a diagram illustrating the movement determining processing of an error occurrence volume. In FIG. 11, the volume management unit 35 determines whether the access request targets the bulk writing medium (VG1) 15 (Operation S301).

If the access request does not target the bulk writing medium (VG1) 15 (NO in Operation S301), the process goes to the determination in Operation S401 (Operation S307). If the access request targets the bulk writing medium (VG1) 15 (YES in Operation S301), the volume management unit 35 obtains the number of times of error occurrence of one volume processing of the access target (Operation S302).

The volume management unit 35 records the obtained number of times of error occurrence in the field for the data error number of the access target volume (Operation S303). The volume management unit 35 calculates an average value RTClav of the number of times of retry of all the volumes (Operation S304).

If the number of times of retry of the access target volume is larger than a first threshold value (YES in Operation S305), the volume management unit 35 adds the error frequent occurrence mark to the volume (Operation S306). That is, the volume management unit 35 records Y in the field for the error frequent occurrence mark of the access target volume in the volume management table. The process goes to the determination in Operation S401 (Operation S307).

In this case, the first threshold value may be set to 80 percent of the upper limit of retryout at a prescribed time of error, for example. The upper limit value of retryout indicates the number of times of retryout at a time of error that is set by data block unit included in the volume based on an operation mode of the write processing or the read processing of the drive.

With respect to the volume of which the number of times of retry exceeds the first threshold value, the volume management unit 35 adds the error frequent occurrence mark as a movement candidate in the volume management table. If the retry occurrence is cleared (count 0) before the volume movement due to a temporary occurrence, the volume management unit 35 releases the error frequent occurrence mark of the volume.

If the number of times of retry of the access target volume is equal to or smaller than the first threshold value (NO in Operation S305), the volume management unit 35 determines whether the number of times of retry is 0. If the number of times of retry of the access target volume is 0 (YES in Operation S308), the volume management unit 35 releases the error frequent occurrence mark of the access target volume and clears the field for the error frequent occurrence mark in the volume management table (Operation S309). If the number of times of retry is not 0, the process goes to the determination in Operation S310.

If the number of times of error correction of the access target volume is larger than the second threshold value (YES in Operation S310), the process goes to the processing in Operation S306. If the number of times of error correction is equal to or smaller than the second threshold value (NO in Operation S310), the volume management unit 35 determines whether the number of times of retry is 0.

The second threshold value may be set to 50 percent of the upper limit value of a prescribed number of times of error correction, for example. The upper limit value is determined by an operation mode of the write processing or the read-out processing of the tape drive and indicates the upper limit value of the number of times of performance of error correction processing of the data error generated whet the data is read out from the medium.

With respect to the volume with the number of times of error correction exceeding the second threshold value, the volume management unit 35 adds the error frequent occurrence mark as the movement candidate to the volume management table. If the error occurrence is cleared (count 0) before the volume movement due to a temporary error occurrence, the volume management unit 35 releases the error frequent occurrence mark of the volume.

If the number of times of retry of the access target volume is 0 (YES in Operation S311), the volume management unit 35 releases the error frequent occurrence mark and clears the field for the error frequent occurrence mark in the volume management table (Operation S312). The process goes to the determination in Operation S314 (Operation S313). If the retry number is not 0 (NO in Operation S311), the process goes to the determination in Operation S314 (Operation S313).

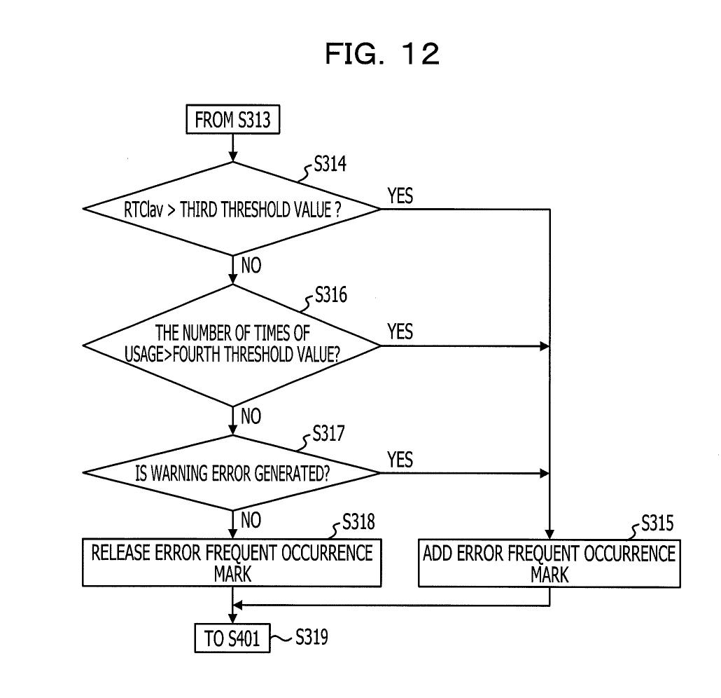

FIG. 12 is a diagram illustrating the movement determining processing of the error occurrence volume and illustrating the processing following Operation S313. If the average value RTClav of the number of times of retry is larger than the third threshold value (YES in Operation S314), the volume management unit 35 adds the error frequent occurrence mark to all the volumes (Operation S315). That is, the volume management unit 35 records Y in the field for the error frequent occurrence mark of all the volumes in the volume management table.

The third threshold value may be set to 40 percent of the above-described prescribed upper limit value of retryout, for example. The process goes to the determination in Operation S401 (Operation S319). If the average value RTClav of the number of times of retry is equal to or smaller than the third threshold value (NO in Operation S314), the volume management unit 35 obtains the number of times of usage of the bulk writing medium (VG1) 15 recorded in the volume management table.

The number of times of usage is larger than the fourth threshold value (YES in Operation S316), the volume management unit 35 adds the error frequent occurrence mark to all the volumes. That is, the volume management unit 35 records Y in the field for the error frequent occurrence mark of all the volumes in the volume management table (Operation S315). The process goes to the determination in Operation S401 (Operation S319).

The number of times of usage is equal to or smaller than the fourth threshold value (NO in Operation S316), the volume management unit 35 determines whether an warning error is generated in the first drive (D1) 17. In this case, the fourth threshold value is generally set to 80 percent of a prescribed usage limit specified value, for example. The usage limit specified value indicates the number of mount upper limit that is specified base on the number of times of usage (life) specification determined as a usage standard of the medium.

In the write/read-out processing unit in the first drive (D1) 17, that is, hardware such as a magnetic tape head, if the warning error indicating character deterioration or a sign of the life end is generated (YES in Operation S317), the volume management unit 35 adds the error frequent occurrence mark to all the volumes (Operation S315). The process goes to the determination in Operation S401 (Operation S319). If the warning error is not generated in the first drive (D1) 17 (NO in Operation S317), the volume management unit 35 releases the error frequent occurrence mark (Operation S318). The process goes to the determination in Operation S401 (Operation S319).

Moving processing of the volumes will be described below. If there is a rewriting access from the host computer 2 with respect to the volume added with the movement candidate mark, the volume management unit 35 performs the reallocation associated with the inter-medium movement of the volume during the rewrite processing.

When the rewrite processing is performed on the desired volume of the bulk writing medium (VG1) 15, the volume management unit 35 additionally writes the data of the volume of the rewriting target in the last edge. The volume management unit 35 invalidates the volume in the volume management table of the bulk writing medium (VG1) 15. That is, the volume management unit 35 deletes the flag in the field for the valid flag of the volume in the volume management table.

When the reallocation associated with the inter-medium movement is performed, the volume data as a rewriting target is additionally written into the medium (VG2) 16 in the second drive (D2) 18 by the processing of the control unit 20. After that, invalidating the volume in the volume management table on the side of the bulk writing medium (VG1) 15, the volume management unit 35 moves the volume.

The read-out processing on the volume of the bulk writing medium (VG1) 15 is performed by the host computer 2, the data of the read-out volume is transferred to the host computer 2. At this time, the volume management unit 35 temporally stores the data in the copy data buffer unit 33 as well. Further, the volume management unit 35 copies the volume by additionally writing the data stored in the copy data buffer unit 33 in the medium (VG2) 16 of the second drive (D2) 18.

After completing the reading-out on the side of the bulk writing medium (VG1) 15 and the copying to the medium (VG2) 16, the volume management unit 35 invalidates the volume in the volume management table on the side of the bulk writing medium (VG1) 15. That is, the volume management unit 35 deletes the flag in the field for the valid flag of the volume in the volume management table. Due to this, the reallocation associated with the inter-medium movement is completed. In this manner, if the second drive (D2) 18 is usable, the reading-out and the movement are concurrently performed.

If the second drive (D2) 18 is unusable, the movement of the volume as a movement target is not performed, and the regular read-out processing from the bulk writing medium (VG1) 15 is performed. With respect to the volume that is not subjected to the rewrite processing by the host computer 2, the reallocation associated with the inter-medium movement is performed on both the medium (VG1) 15 and the medium (VG2) 16 in the standby state with no access from the host computer 2.

The volume management unit 35 performs copying of the data of the volume by reading out the data of the volume of the bulk writing medium (VG1) 15 of the first drive (D1) 17 and writing the data into the medium (VG2) 16 of the second drive (D2) 18.

After completing the copying of the data of the volume, the volume management unit 35 ends the reallocation associated with the inter-medium movement by invalidating the volume in the volume management table of the bulk writing medium (VG1) 15. By repeating the above-described three operations, the volume as a movement target is moved. The reallocation associated with the inter-medium movement from the second drive (D2) 18 of the medium (VG2) 16 to the bulk writing medium (VG1) 15 of the first drive (D1) 17 may be performed. In this case, the above-described movement source may be replaced by the above-described movement destination.

The moving processing of the volume as a movement candidate is preferentially performed on the volume with frequent reading-out, and the reallocation associated with the inter-medium movement to be performed concurrently with the reading-out access is performed. During the above-described reallocation, if there is a writing access, volume is written into the movement destination, and the reallocation associated with the inter-medium movement is performed in concurrence with the writing access. After that, while there is no access, the volume of the rest of the movement candidate is moved.

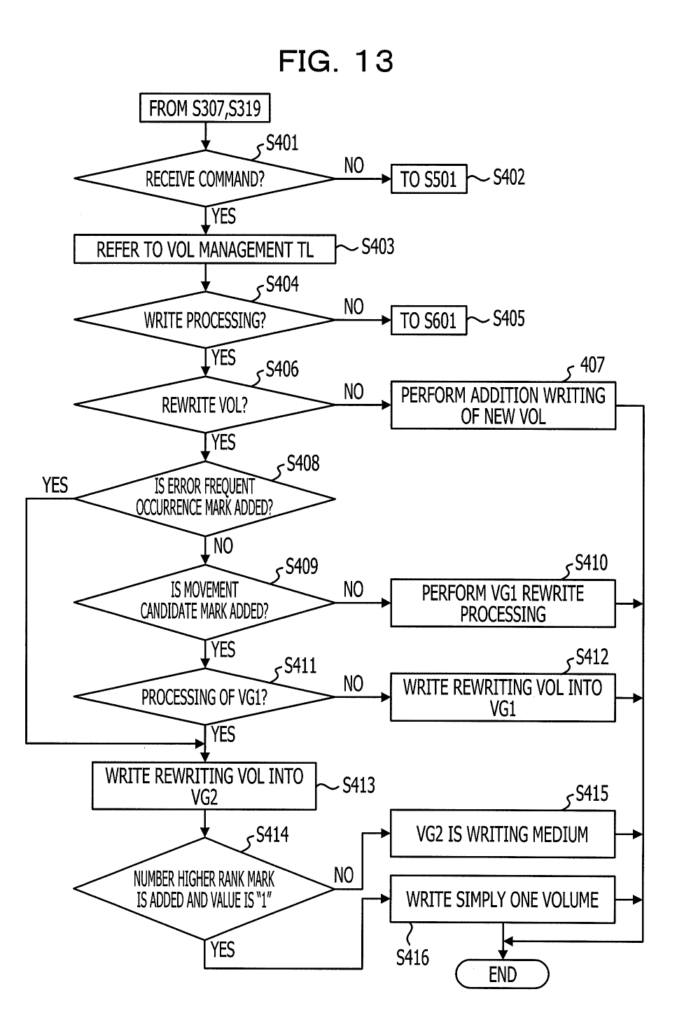

FIG. 13 is a diagram illustrating moving processing of a volume. In FIG. 13, the volume management unit 35 determines whether the first drive (D1) 17 and the second drive (D2) 18 receive the command of the access request from the command standby state in the host computer 2. If the command is not received (NO in Operation S401), the process goes to the determination in Operation S501 (Operation S402).

If the command is received (YES in Operation S401), the volume management unit 35 refers to the volume management table of the access target volume (Operation S403). If the access request does not indicate the write processing with respect to the access target volume (NO in Operation S404), the process goes to the read processing in Operation S601 (Operation S405).

If the access request indicates the write processing (YES in Operation S404), the volume management unit 35 determines whether the access request indicates the rewrite processing of the volume. If the access request does not indicate the rewrite processing of the volume (NO in Operation S406), the volume management unit 35 performs the addition writing of the new volume (Operation S407).

If the access request indicates the write processing of the volume (YES in Operation S406), the volume management unit 35 determines whether the error frequent occurrence mark is added to the access target volume (Operation S408). If the error frequent occurrence mark is added (YES in Operation S408), the process goes to Operation S413. If the error frequent occurrence mark is not added (NO in Operation S408), the volume management unit 35 determines whether the movement candidate mark is added to the access target volume (Operation S409).

If the movement candidate mark is not added (NO in Operation S409), the volume management unit 35 performs the regular rewrite processing of the bulk writing medium (VG1) 15 without performing the reallocation associated with the inter-medium movement (Operation S410). If the movement candidate mark is added (YES in Operation S409), the volume management unit 35 determines whether the write processing is the processing of the bulk writing medium (VG1) 15 (Operation S411).

If the write processing is not the processing of the bulk writing medium (VG1) 15 (NO in Operation S411), the volume management unit 35 performs processing for writing the data set of the rewriting target volume into the bulk writing medium (VG1) 15 (Operation S412). The volume management unit 35 invalidates the rewriting target volume in the volume management table on the side of the medium (VG2) 16.

If the write processing is the processing of the bulk writing medium (VG1) 15 (YES in Operation S411), the volume management unit 35 performs the write processing of the data set of the rewriting target volume into the medium (VG2) 16 (Operation S413). After that, the volume management unit 35 invalidates the rewriting target volume in the volume management table on the side of the bulk writing medium (VG1) 15.

The volume management unit 35 determines whether the number higher rank mark is added to the access target volume (Operation S414). If the number higher rank mark is not added or if the value of the number higher rank mark is equal to or larger than 2 (NO in Operation S414), the medium (VG2) 16 becomes a bulk writing medium that performs the bulk-write processing (Operation S415). If the number higher rank mark is added and if the value is 1 (YES in Operation S414), the volume management unit 35 performs regular write processing simply on one volume of the access target (Operation S416). That is, the medium (VG2) 16 as a single volume medium is subjected to the regular write processing instead of the bulk-write processing.

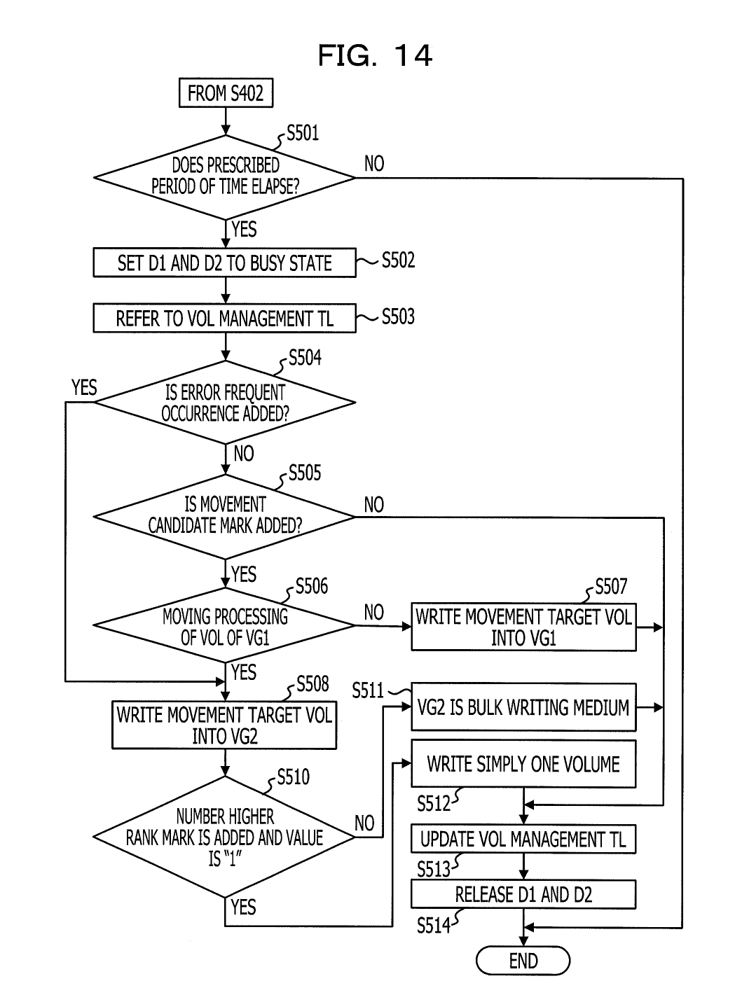

FIG. 14 is a diagram illustrating moving processing of a volume and illustrating the processing following Operation S402. In FIG. 14, the volume management unit 35 determines whether a prescribed period of time elapses after the previous command reception (Operation S501).

If the prescribed period of time elapses (YES in Operation S501), the control unit 20 sets the first drive (D1) and the second drive (D2) to a BUSY state, so that the command from the host computer 2 is not received (Operation S502). If the prescribed period of time does not elapse (NO in Operation S501), the process ends (END). The prescribed period of time may be a time that is set at shipment or a time that is set by a user.

The volume management unit 35 refers to the volume management table of the medium of the moving processing target (Operation S503). The volume management unit 35 determines whether the volume added with the error frequent occurrence mark exists in the volume management table (Operation S504).

If the volume added with the error frequent occurrence mark exists (YES in Operation S504), the process goes to the processing in Operation S508. If the volume added with the error frequent occurrence mark does not exist (NO in Operation S504), the volume management unit 35 determines whether the volume added with the movement candidate mark exists in the volume management table (Operation S505).

If the volume added with the movement candidate mark does not exist (NO in Operation S505), the process goes to the processing in Operation S513. If the volume added with the movement candidate mark exists (YES in Operation S505), the volume management unit 35 determines whether the volume of the bulk writing medium (VG1) 15 is subjected to the moving processing (Operation S506).

If the volume of the bulk writing medium (VG1) 15 is not subjected to the moving processing (NO in Operation S506), the volume management unit 35 reads out the data set of the volume, to which the movement candidate mark is added, from the medium (VG2) 16 and then writes the read-out data set into the bulk writing medium (VG1) 15. The volume management unit 35 invalidates the volume in the volume management table on the side of the medium (VG2) 16 (Operation S507). The process goes to the processing in Operation S513.

If the volume of the bulk writing medium (VG1) 15 is subjected to the moving processing (YES in Operation S506), the volume management unit 35 reads out the data set of the volume added with the movement candidate mark and then writes the read-out data set into the medium (VG2) 16. After that, the volume management unit 35 invalidates the volume in the volume management table on the side of the bulk writing medium (VG1) 15 (Operation S508).

The volume management unit 35 determines whether the number higher rank mark is added to the volume (Operation S510). If the number mark is not added or if the value of the number higher rank mark is equal to or larger than 2 (NO in Operation S510), the medium (VG2) 16 is assumed to be a bulk writing medium, and the bulk-write processing is performed (Operation S511).

If the number higher rank mark is added and if the value of the number higher rank mark is 1 (YES in Operation S510), the volume management unit 35 performs the regular write processing simply on one volume of which the number of accesses of the movement target is largest (Operation S512). That is, the medium (VG2) 16 is handled as a single volume medium, so that the regular write processing is performed instead of the bulk-write processing.

The volume management unit 35 updates the volume management table of the volume (Operation S513), and the control unit 20 releases the drive (D1) and the drive (D2) from the BUSY state and puts the drive (D1) and the drive (D2) in a command standby state in which a command from the host computer 2 may be received (Operation S514).

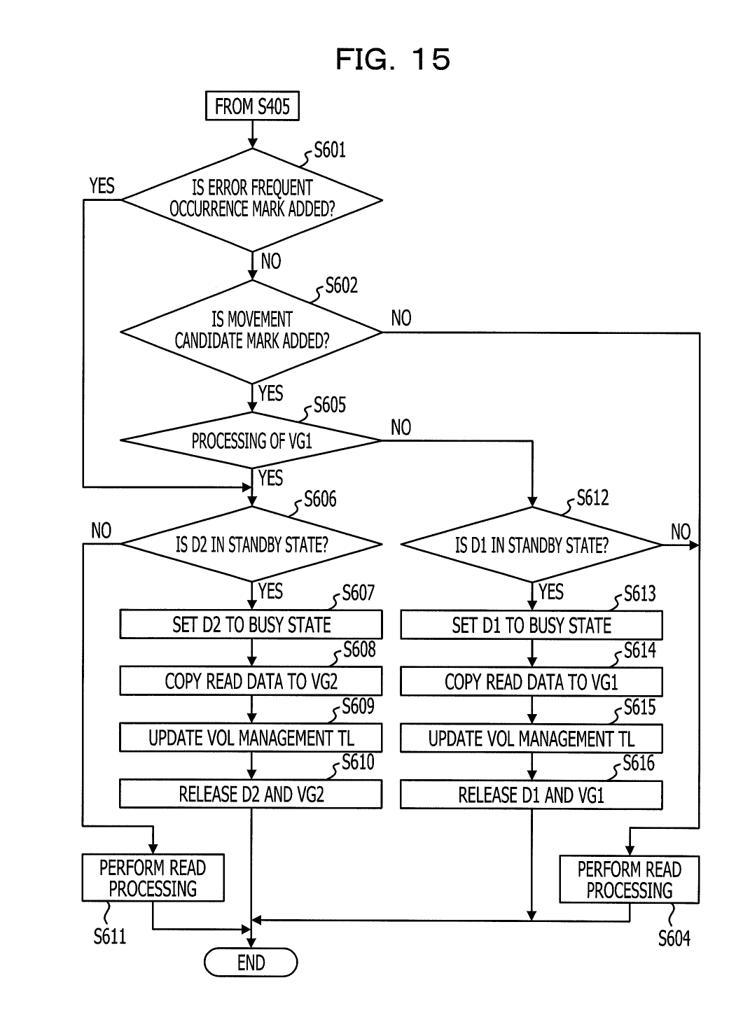

FIG. 15 is a diagram illustrating moving processing of volume and illustrating the processing following Operation S405. FIG. 15 illustrates a case where the access request indicates the read processing with respect to the access target volume. The volume management unit 35 refers to the volume management table. If the error frequent occurrence mark is added to the access target (YES in Operation S601), the process goes to the processing in Operation S606.

The error frequent occurrence mark is not added to the access target volume (NO in Operation S601), the volume management unit 35 refers to the volume management table to determine whether the movement candidate mark is added (Operation S602). If the movement candidate mark is not added (NO in Operation S602), the process goes to the processing in Operation S604.

If the movement candidate mark is added to the access target volume (YES in Operation S602), the volume management unit 35 determines whether the read processing is the processing of the bulk writing medium (VG1) 15 (Operation S605).

If the read processing is the processing of the bulk writing medium (VG1) 15 (YES in Operation S605), the volume management unit 35 confirms whether the second drive (D2) 18 is in the command standby state. If the second drive (D2) 18 is not in the command standby state (NO in Operation S606), the second drive (D2) 18 is being used, so that the regular read processing is performed (Operation S611). Due to this, in this case, the reallocation associated with the inter-medium movement is not performed.

If the second drive (D2) 18 is in the command standby state, the volume management unit 35 sets the second drive (D2) 18 into which the medium (VG2) 16 is loaded to a BUSY state (Operation S607). At a time of reading out the access target volume, the volume management unit 35 copies the read data, which is to be transferred to the host computer 2, to the medium (VG2) 16 (Operation S608).

After completing the read-out processing and the copy processing, the volume management unit 35 invalidates the movement target volume in the volume management table of the bulk writing medium (VG1) 15 and updates the volume management table of the medium (VG2) 16 (Operation S609).

The volume management unit 35 releases the second drive (D2) 18 and the medium (VG2) 16 from the BUSY state and then puts the second drive (D2) 18 and the medium (VG2) 16 in the command standby state in which the command from the host computer 2 may be received (Operation S610).

If the read processing is not the processing of the bulk writing medium (VG1) 15 (NO in Operation S605), the volume management unit 35 confirms whether the processing target is the medium (VG2) 16 and whether the first drive (D1) 17 is in the command standby state (Operation S612). If the first drive (D1) 17 is not in the command standby state (NO in Operation S612), the volume management unit 35 performs the regular read processing (Operation S604). Due to this, in this case, the reallocation associated with the inter-medium movement is not performed.

If the first drive (D1) 17 is in the command standby state (YES in Operation S612), the first drive (D1) 17, into which the bulk writing medium (VG1) 15 is loaded, is set to the BUSY state (Operation S613). At a time of reading out the access target volume, the volume management unit 35 copies the read data, which is to be transferred to the host computer 2, to the bulk writing medium (VG1) 15 (Operation S614).

After completing the read-out processing and the copy processing, the volume management unit 35 invalidates the movement target volume in the volume management table of the medium (VG2) 16 and updates the volume management table of the bulk writing medium (VG1) 15 (Operation S615).

The volume management unit 35 releases the first drive (D1) 17 and the bulk writing medium (VG1) 15 from the BUSY state and puts the first drive (D1) 17 and the bulk writing medium (VG1) 15 in the command standby state in which the command from the host computer 2 may be received (Operation S616).

Data maintenance processing at a time of a sign of a drive failure or the life end of the medium will be described below. The embodiments describe an example of two medium concurrently used in two drives as described above. The embodiments describe an example of a storage apparatus that includes a combined function of a function of access load distribution by using the bulk writing medium and the medium that collects the volumes with high usage frequency and a function for transferring the error high frequent medium to the normal medium due to monitoring of an error of data writing/reading-out.

With the access load distribution function, the volume with multi-access is moved from the bulk writing medium (VG1) 15 to the multi-access medium (VG2) 16. By the medium life/drive failure management function, the volume with a large number of times of error occurrence is evacuated to the multi-access medium (VG2) 16.

With respect to the state in which both the functions are operated, based on the usage frequency at a time of error high frequent occurrence that is larger than the specified value of the bulk writing medium (VG1) 15, the access load distribution processing for moving the volumes between the multi-access medium (VG2) 16 and the bulk writing medium (VG1) 15 is stopped, and the processing for evacuating all the volumes to the multi-access medium (VG2) 16 is preferentially performed.

After the movement of all the volumes to the multi-access medium (VG2) 16 is completed, the original bulk writing medium (VG1) 15 is invalidated, the new medium (VG2) 16 is handled as a new bulk writing medium (VG1), and the operation is switched to the operation simply for the bulk writing medium (VG1) 15.

If the medium failure or the sign of the life end of the medium is generated in the bulk writing medium (VG1) 15, the access load distribution function becomes valid again after the new medium is mounted. The processing starts with the new medium as another multi-access medium (VG2).

If a failure or a life end sign is generated in the first drive (D1) 17, the bulk-write processing in which the usage of the first drive (D1) 17 is stopped, and the second drive (D2) 18 and all the volumes are reallocated is performed by the new bulk writing medium (VG1). After the first drive (D1) 17 is replaced by the new medium to be mounted, the access load distribution function is validated with the new medium as another multi-access medium (VG2).

After the access load distribution function is validated, due to the above-described processing, the function for moving the volume with many accesses to the multi-access medium (VG2) is operated and transferred to be in a state in which the access load distribution is optimized. The moving processing of volume is performed in the similar manner as described above.

On the other hand, in the volume that is moved to the multi-access medium (VG2) 16, when errors occur frequently as described above, that is, when a medium failure is generated or a failure sign of the second drive (D2) 18 is generated, the access load distribution function is stopped. All the volumes of the multi-access medium (VG2) 16 rewritten on the side of the bulk writing medium (VG1) 15, and the multi-access medium (VG2) 16 and the second drive (D2) 18 are closed. The mode is switched to the processing mode simply for the first drive (D1) 17 and the bulk writing medium (VG1) 15.

If a failure sine or a life end sign is generated in the second drive (D2) 18, the second drive (D2) 18 is exchanged. After the new medium is mounted, the new medium is set to another new multi-access medium (VG2), so that the access load distribution function becomes valid.

If the failure sign or the life end sign is generated in the multi-access medium (VG2) 16, the new medium is set to another new multi-access medium (VG2) after the new medium is mounted, and then the access load distribution function becomes valid. The moving processing of volume is performed as described above. The moving processing has a procedure in which the medium (VG1) is replaced by the medium (VG2) and the drive (D1) is replaced by and the drive (D2) in the description above.

In this manner, the data maintenance is performed while performing an effective operation as the access load distribution by the bulk writing and partially division of the plurality of volumes to the large-capacity medium. That is, before either the medium (VG1) and the medium (VG2) or the drive (D1) and the drive (D2) becomes unusable, the data movement of all the volumes from the abnormality sign medium to the normal medium is automatically performed in both directions. Due to this, the data of all the volumes that are assigned to the bulk writing medium is protected before a failure occurs.

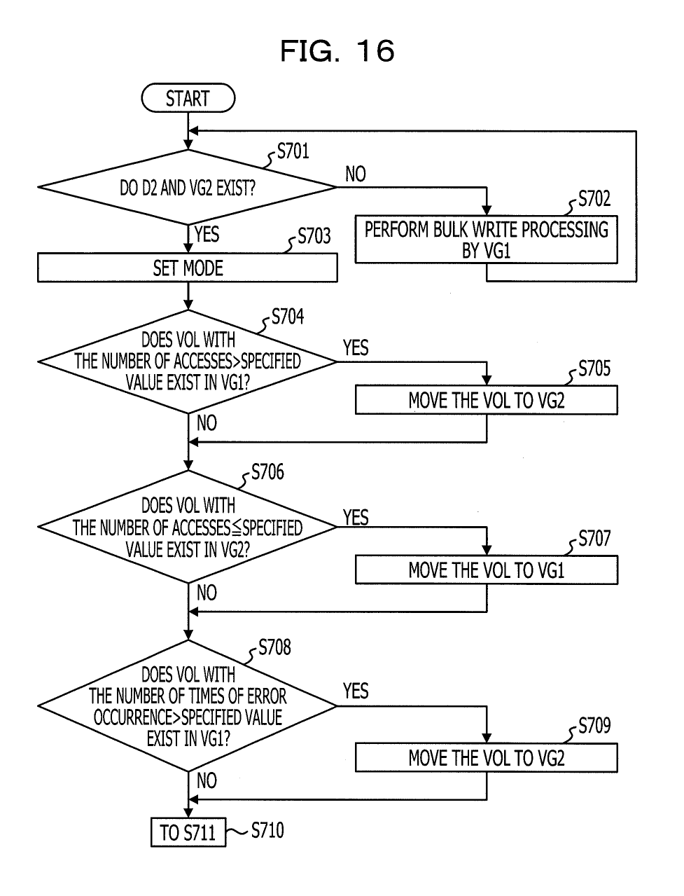

FIG. 16 is a diagram illustrating collective moving processing of all the volumes. The volume management unit 35 determines whether the second drive (D2) 18 and the medium (VG2) 16 exist inside the magnetic tape device (Operation S701).

If the second drive (D2) 18 and the medium (VG2) 16 do not exist (NO in Operation S701), the volume management unit 35 performs the bulk-write processing by using the bulk writing medium (VG1) 15 (Operation S702). The process goes back to the determination in Operation S701. If the second drive (D2) 18 and the medium (VG2) 16 exist and if two drives and two mediums are usable (YES in Operation S701), the volume management unit 35 sets a mode flag to the load distribution processing mode (Operation S703).

The volume management unit 35 refers to the volume management table of the bulk writing medium (VG1) 15 to determine whether the volume of which the number of accesses is larger than a prescribed specified value (Operation S704). The specified value is, for example, the average value of the number of accesses of all the volumes of the bulk writing medium (VG1) 15. The number of times of read processing and the number of times of write processing may be separately used as the number of accesses. The total number of times of read processing and of times of write processing may be used as the number of accesses.

If the volume exists (YES in Operation S704), the volume management unit 35 moves the volume to the medium (VG2) 16 and updates the volume management table of the volumes of the movement source and the movement destination (Operation S705).

As with the medium (VG2) 16, the volume management unit 35 refers to the volume management table to determine whether the volume of which the number of accesses is equal to or smaller than the prescribed specified value exists. The specified value is, for example, the average value of the number of accesses of all the volumes of the VG2.

If the volume exists (YES in Operation S706), the volume management unit 35 moves the volume to the bulk writing medium (VG1) 15 and updates the volume management table of each medium (Operation S707).

The volume management unit 35 refers to the volume management table of the bulk writing medium (VG1) 15 to determine whether the volume, of which the number of times of error occurrence is larger than the prescribed specified value, exists (Operation S708). If the volume exists (YES in Operation S708), the volume management unit 35 moves the volume to the medium (VG2) 16 and updates the volume management table at the movement source and the movement destination (Operation S709).

FIG. 18 is a diagram illustrating the collective moving processing of all the volumes and illustrating the processing following Operation S710. The volume management unit 35 refers to the volume management table of the medium (VG2) 16 to determine whether the volume, of which the number of times of error occurrence is larger than the prescribed specified value, exists (Operation S711). If the volume exists (YES in Operation S711), the volume management unit 35 moves all the volumes of the medium (VG2) 16 to the bulk writing medium (VG1) 15 (Operation S712).

The volume management unit 35 invalidates the medium (VG2) 16 and closes the second drive (D2) 18 (Operation S713). Regarding the invalidation of the medium (VG2) 16, the volume management table at the movement source and the movement destination is updated. The volume management unit 35 releases the load distribution processing mode and clears the mode flag (Operation S714). The process goes back to the processing in Operation S701 (Operation S715).

If the volume, of which the number of times of error occurrence is larger than the specified value, does not exist (NO in Operation S711), the volume management unit 35 refers to the volume management table of the bulk writing medium (VG1) 15 (Operation S716). If the number of error volumes is not larger than the specified value (NO in Operation S716), the process goes back to Operation S705 (Operation S717).

If the number of error volumes is larger than the specified value (YES in Operation S716), the volume management unit 35 moves all the volumes of the bulk writing medium (VG1) 15 to the medium (VG2) 16 (Operation S718). The volume management unit 35 invalidates the bulk writing medium (VG1) 15 and closes the first drive (D1) 17 (Operation S719). Regarding the invalidation of the bulk writing medium (VG1) 15, the volume management table at the movement source and the movement destination is updated.

The volume management unit 35 releases the load distribution processing mode and clears the mode flag (Operation S720). The volume management unit 35 performs the bulk-write processing by using the medium (VG2) 16 (Operation S721). The volume management unit 35 sets the medium (VG2) 16 as a bulk writing medium and sets the newly loaded medium to the first drive (D1) 17 as a new medium at the movement destination.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A storage apparatus comprising:
a storage drive which writes and reads out a block of data with respect to a storage medium loaded on the storage apparatus;
a processor which executes access control on a plurality of volumes assigned to the storage medium; and
a memory which stores a piece of management information that includes a piece of information indicating a usage frequency of each of the volumes,
the processor executes a procedure including:
determining a reallocation target volume from among a plurality of volumes assigned to the storage medium based on the management information, and
moving the data of the reallocation target volume to a reallocation destination storage medium which is different from the storage medium.

2. The storage apparatus according to claim 1, wherein the information indicating the usage frequency represents the number of times of processing for one of reading-out and writing with respect to each of the volumes, and
the determining determines the reallocation target volume based on a comparison result of the number of times of the processing and a first specified value.

3. The storage apparatus according to claim 2, wherein the first specified value is specified based on an average value of the number of times of the processing for at least one of the writing and the reading-out with respect to all the volumes assigned to the storage medium.

4. The storage apparatus according to claim 1, wherein the management information includes a piece of information indicating an error occurrence state, and
the determining determines the reallocation target volume based on the information indicating the error occurrence state.

5. The storage apparatus according to claim 4, wherein
the information indicating the error occurrence state is one of the number of times of retry and the number of times of error correction of each of the volumes, and
the determining determines the reallocation target volume based on a comparison result of a second specified value and at least one of the number of times of retry and the number of times of error correction.

6. The storage apparatus according to claim 5, wherein the second specified value is specified based on an average value of at least one of the number of times of retry and the number of times of error correction of all the volumes assigned to the storage apparatus.

7. The storage apparatus according to claim 1, wherein
the management information include the information indicating the usage frequency of the storage medium, and
the determining determines all volumes assigned to the storage medium as the reallocation target volume based on a comparison result of the usage frequency of the storage medium and a third specified value.

8. A system comprising:
a computer; and
a storage apparatus, the storage apparatus including:
a storage drive which writes and reads out a block of data with respect to the storage medium loaded on the storage apparatus,
a processor which executes access control on a plurality of volumes assigned to the storage medium based on a command received from the computer, and
a memory which stores a piece of management information that includes a piece of information indicating a usage frequency of each of the volumes,
the processor executes a procedure including:
determining a reallocation target volume from among a plurality of volumes assigned to the storage medium based on the management information, and
moving the data of the volume as the reallocation target to another storage medium of a reallocation destination which is different from the storage medium.

9. A control method of a storage apparatus which accesses a block of data with respect to a storage medium to which a plurality of volumes is assigned, the method comprising:
obtaining a piece of management information that includes a piece of information indicating a usage frequency of each of the volumes;
determining a reallocation target volume from among a plurality of volumes assigned to the storage medium based on the management information; and
moving the data of the reallocation target volume to a reallocation destination storage medium which is different from the storage medium.

10. The control method according to claim 9, wherein the information indicating the usage frequency represents the number of times of processing for one of reading-out and writing with respect to each of the volumes, and
the determining determines the reallocation target volume based on a comparison result of the number of times of the processing and a first specified value.

11. The control method according to claim 10, wherein the first specified value is specified based on an average value of the number of times of the processing for at least one of the writing and the reading-out with respect to all the volumes assigned to the storage medium.

12. The control method according to claim 9, wherein the management information includes a piece of information indicating an error occurrence state, and
the determining determines the reallocation target volume based on the information indicating the error occurrence state.

13. The control method according to claim 12, wherein
the information indicating the error occurrence state is one of the number of times of retry and the number of times of error correction of each of the volumes, and
the determining determines the reallocation target volume based on a comparison result of a second specified value and at least one of the number of times of retry and the number of times of error correction.

14. The control method according to claim 13, wherein the second specified value is specified based on an average value of at least one of the number of times of retry and the number of times of error correction of all the volumes assigned to the storage apparatus.

15. The control method according to claim 9, wherein
the management information include the information indicating the usage frequency of the storage medium, and
the determining determines all volumes assigned to the storage medium as the reallocation target volume based on a comparison result of the usage frequency of the storage medium and a third specified value.
